(19) United States
(12) Patent Application Publication
(10) Pub. No.: US 2008/0296467 A1
(43) Pub. Date: Dec. 4, 2008

(54) SUSPENSION SYSTEM

(76) Inventors: JONATHAN N. HAVELOCK, EDMONTON (CA); PETER T. SEKULIC, EDMONTON (CA); STJEPAN BALENOVIC, EDMONTON (CA); BERNIE FUCHS, EDMONTON (CA); HERBERT GUNDERMANN, EDMONTON (CA)

Correspondence Address: DYKAS, SHAVER & NIPPER, LLP, P.O. BOX 877, BOISE, ID, 83701-0877, US

(21) Appl. No.: 11/755,178

(22) Filed: May 30, 2007

(51) Int. Cl. F16M 13/00; A47G 1/16

(52) U.S. Cl. 248/544

(57) ABSTRACT

An improved hanger is provided that has a mounting block through which a shaft is threaded. One or more hooks are threaded onto with one or more mount receiving slots inline with the shaft. Inverted mount receiving slots are provided. The mounting block may be mounted directly to a wall or using a bracket on which the mounting block may be adjusted laterally.

### BACKGROUND

A large variety of devices are known for hanging objects, such as pictures, from a wall. Adjustment of the object location can be difficult since often the hanger is located behind the object being mounted. It is common for a person to have to move the hanger after installation of the hanger, thus causing more damage to the wall each time the hanger is relocated. Some adjustable designs are known, but a difficulty with at least some of them is that the weight of the object being suspended may be born by a mounting surface that is further from the wall than desirable, thus placing undesirable leverage on the hanger.

### SUMMARY

An improved suspension system or hanger is provided that in an embodiment has a mounting block through which a shaft extends, as for example by being threaded. In one embodiment, one or more hooks are secured as by threading onto the shaft with one or more mount receiving slots inline with the shaft. In another embodiment, inverted mount receiving slots are provided in the hook. The mounting block may be mounted directly to a wall or using a bracket on which the mounting block may be adjusted laterally. These and other aspects of the device are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of an embodiment of a hanger;

FIG. 2 is front view of the embodiment of FIG. 1;

FIG. 3 is a bottom view of the embodiment of FIG. 1;

FIG. 4 is a side view of a hook and shaft for use in an embodiment of a hanger;

FIG. 5 is a perspective view of a mounting block used in the embodiment of FIG. 1;

FIG. 6 is a perspective view of an embodiment of a hook;

FIG. 7 is a side view of the hook of FIG. 6;

FIG. 8 is a top view of the hook of FIG. 6; and

FIGS. 9, 10 and 11 are side views of a hook in various mounting positions.

### DETAILED DESCRIPTION

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

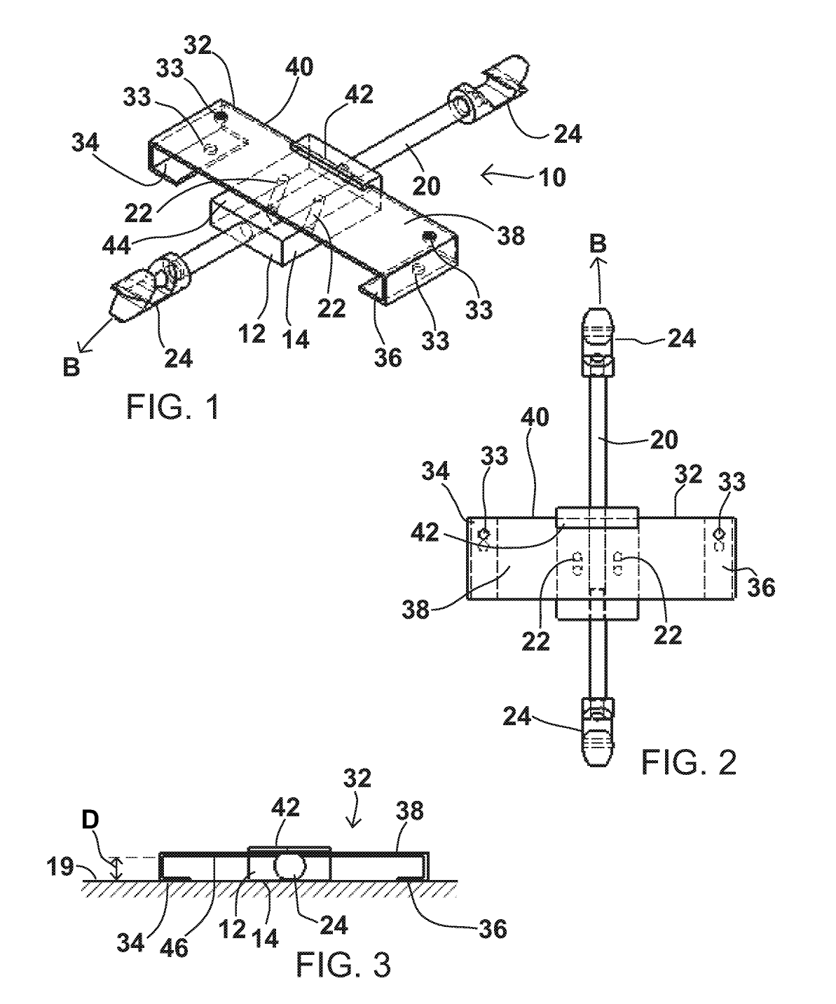

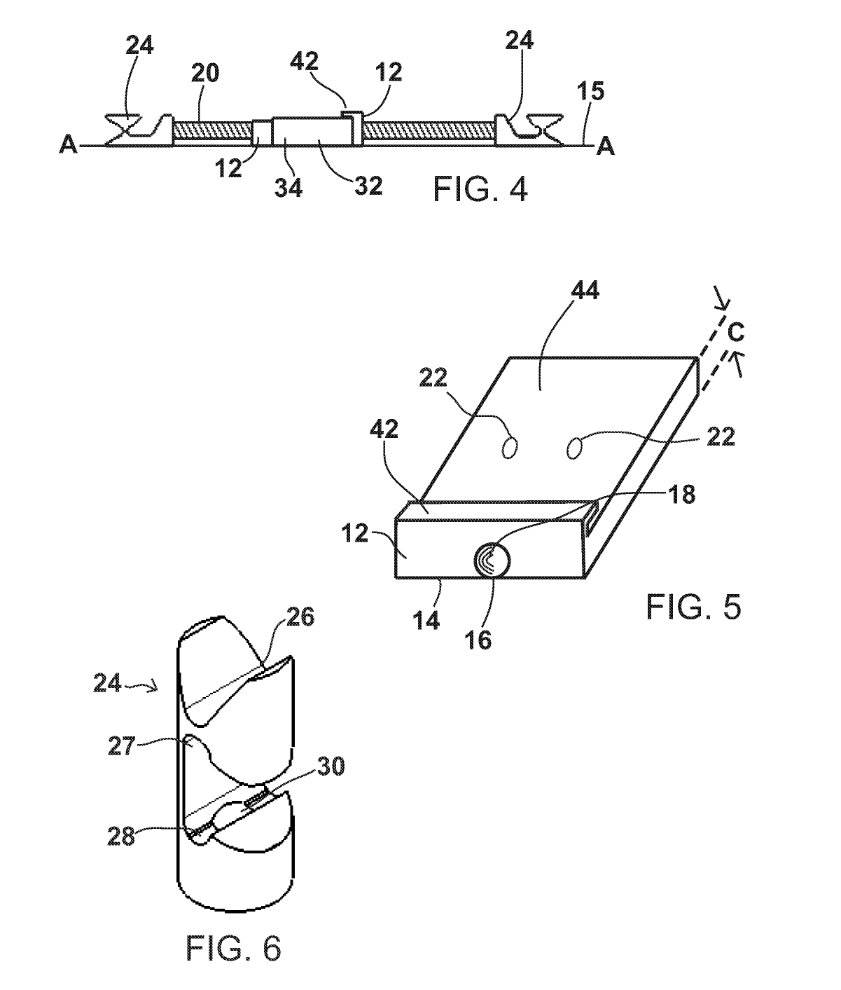

Referring to FIG. 1-3, a hanger 10 comprises a mounting block 12 having a wall mounting face 14 defining a mounting plane 15 which passes through line A-A (FIG. 4) and which in use is coincident with a wall 19 shown in FIG. 3. The mounting block 12 has an internal bore 16 that is at least partially threaded as shown at 18 and may be threaded from end to end. The mounting block 12 may be solid as shown in FIG. 5, but may also in some embodiments have varying amounts of internal void space or spaces, including an embodiment in which the mounting block has six side walls, with threaded portions only in the two side walls. The internal bore 16 extends parallel to the mounting plane 15. In the case of a solid mounting block 12, the bore 16 may be constructed by first forming the mounting block 12 and then drilling the bore 16. In use, the mounting plane will effectively be a surface of a wall 19 on which the hanger 10 is mounted.

In an embodiment, a shaft 20 is threaded into the internal bore 16. The shaft may also be partially threaded, or may in an embodiment have some other adjustable means for locating the shaft 20 in the internal bore 16, such as a ratchet or stick-slip mechanism. Fastener receiving holes 22 pass through the mounting block 12, and in the case of a solid mounting block 12 may be bored through the mounting block 12 as by drilling. The fasteners may for example be nails or screws (not shown). The fastener receiving holes 22 preferably are slanted at a non-zero non-perpendicular axis to the mounting plane 15 so that the fasteners engage a wall 19 in a slanting downward direction. Barbed or ribbed fasteners may be used. One or more hooks 24 are threaded onto the shaft 20 or secured on the shaft 20 by other suitable means such as a twist and lock mechanism. A threaded connection of hooks 24 onto the shaft 20 permits ready height adjustment.

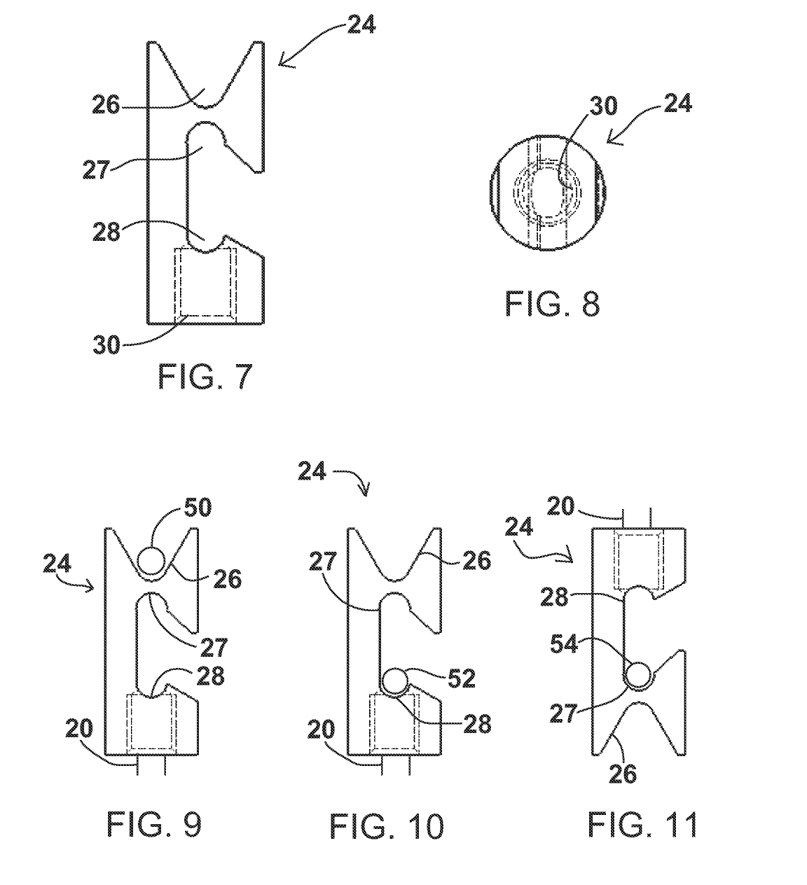

A hook 24 is shown in more detail in FIGS. 6-8. The hook 24 has one or more mount receiving slots 26, 27 and 28. In at least one embodiment, one or more of the slots 26, 27 and 28 are inline with the shaft 20. The result is that when a picture mount, such as a string or wire, or other mount of an object to be hung, is received in the one of the slots 26, 27 or 28, and the mounting block 12 is secured to a wall with the shaft 20 vertical, the weight of the mount is directed downward through the shaft 20. The slots 26, 27 and 28 may receive a string, wire or other mount of a device that is to be suspended from a wall. One use is for suspending a picture from a wire that fits in any one of the slots 26, 27 or 28. In the case of the upper hook 24 shown in FIG. 2, the wire may be received in slot 26 or 28, both of which open in the same direction, which slot 27 opens in the reverse direction. When the hook 24 is on the lower end of the shaft 20, the inverted slot 27 may receive the wire. For pictures or other objects that do not use a wire as a mounting device, such as a picture frame or object having a downward protruding ridge, the ridge may easily be inserted in the slot 26, or in some cases if the ridge is accessible, then in slot 28, when the hook 24 is on the upper end of the shaft 20, or in slot 27 when the hook 24 is on the lower end of the shaft 20.

As shown in FIG. 9, a hook 24 may be mounted on a shaft 20, with a picture mount 50, such as a wire, in slot 26 oriented so that it opens upward. As shown in FIG. 10, a hook 24 may be mounted on a shaft 20, with a picture mount 52, such as a wire, in slot 28 oriented so that it opens upward. As shown in FIG. 11, a hook 24 may be mounted on a shaft 20, with a picture mount 54, such as a wire, in slot 27 oriented so that it opens upward.

In some embodiments, the hook 24 is provided with an internal threaded bore 30 that engages with threads of the shaft 20. With a threaded connection between hook 24 and shaft 20, height adjustment of the hook 24 on the shaft 20 for the slot 26 is limited to half a pitch of the threads on the shaft 20, corresponding to a 180 degree turn of the hook 24 on the shaft 20. For the slots 27 and 28, height adjustment may be limited to a full pitch if the slot has to be accessed from one direction. In some embodiments, the slots 26, 27 and 28 may be offset from axis of the threaded bore 30, hence not be inline with the shaft 20. The inverted mount receiving slot 27 is oriented 180 degrees to the mount receiving slots 26 and 28 about an axis that is perpendicular to the shaft axis B. The hooks 24 may be machined from a suitable bar of material, a cylindrical bar being convenient for making a hook 24. In some embodiments, the hook 24 may also have a pin termination with external threads that threads into a box termination on the shaft 20, or may be secured to the shaft by being integral to the shaft, that is, as a one piece unit, and vertical adjustment obtained only by rotation of the shaft within the mounting block.

The mounting block 12 may be mounted directly on a wall 19 using fasteners passing through holes 22 or may be mounted on a wall 19 using a mounting bracket 32 as for example shown in FIGS. 1-4. The mounting bracket 32 allows ready lateral adjustment of the position of the hooks 24. The mounting bracket 32 may be secured to a wall (not shown) using fasteners passing through holes 33 in side flanges 34, 36. As with holes 22, the holes 33 may be oriented at an angle to the mounting plane 15 to provide strength to the attachment. The mounting 32 has a front plate 38 extending between the side flanges 34, 36 with a laterally extending edge 40. The mounting block 12 incorporates a lip 42 on at least one side face 44. The lip 42 extends perpendicular to the internal bore 16 and is configured to be supported by the laterally extending edge 40 by being sized suitably to receive the edge 40, preferably with a snug but not too tight fit. The lip 42 could snap onto the edge 40, but this makes it difficult for the mounting block 12 to be moved laterally or removed for adjustment. The mounting block 12 preferably has a thickness C equal to or close to, and if close, then preferably slightly less than, the distance D between the inner face 46 of the mounting bracket 32 and the mounting plane 15. The flanges 34, 36 could be continuous with each other, that is, could be end portions of a back wall of the mounting bracket 32, in which case the mounting block 12 would preferably fit between the inner walls of the mounting bracket 32. Such an embodiment with a bracket 32 having a continuous mounting wall brings the mounting block 12 further away from the wall, which makes adjustment of the hooks 24 easier when the hanger 10 is mounted, but moves the mount slightly further away from the wall. The laterally extending edge 40 of the mounting bracket 32 is laterally wider than the lip 42 of the mounting block 12 to allow for lateral movement of the mounting block 12 within the mounting bracket 32. The mounting block 12 may in one embodiment be easily removed from the mounting bracket 32 to allow adjustment of the shaft 20 and hook 24.

The hanger may be used to suspend any suitable object on a wall, such as pictures or ornaments in a residence, or tools in a work shop or garage.

Immaterial modifications may be made to the embodiments described here without departing from what is covered by the claims.

1. A hanger, comprising:
a mounting block having a wall mounting face defining a mounting plane and an internal bore that is at least partially threaded, the internal bore extending parallel to the mounting plane;
a shaft threaded into the internal bore;
fastener receiving holes, each fastener receiving hole passing through the mounting block; and
a hook secured to the shaft, the hook having at least a first mount receiving slot inline with the shaft.

2. The hanger of claim 1 in which the hook is secured to the shaft by threading.

3. The hanger of claim 2 in which the hook has internal threads for threading onto external threads of the shaft.

4. The hanger of claim 1 in which the mounting block is a solid block through which holes have been bored for the internal bore and the fastener receiving holes.

5. The hanger of claim 1 in which the hook comprises an inverted mount receiving slot inline with the shaft, the inverted mount receiving slot being oriented 180 degrees to the first mount receiving slot.

6. The hanger of claim 1 in which the first mounting slot opens in a first direction, and the hook comprises a second mount receiving slot opening in the first direction.

7. The hanger of claim 1, further comprising:
a mounting bracket having a laterally extending edge;
the mounting block incorporating a lip extending perpendicular to the internal bore, the lip being configured to be supported by the laterally extending edge; and
the laterally extending edge being laterally wider than the lip of the mounting block.

8. A hanger, comprising:
a mounting block having a wall mounting face defining a mounting plane and an internal bore, the internal bore extending parallel to the mounting plane;
a shaft in the internal bore and having adjustable means to locate the shaft in the internal bore;
fastener receiving holes, each fastener receiving hole passing through the mounting block;
a hook mounted on the shaft, the hook having at least a first mount receiving slot;
a mounting bracket having a front face with a laterally extending edge;
the mounting block incorporating a lip extending perpendicular to the internal bore, and being supported by the mounting bracket with the lip resting on the laterally extending edge and the mounting block between a wall and the front face of the mounting bracket; and
the laterally extending edge being laterally wider than the lip of the mounting block.

9. The hanger of claim 8 in which the mounting block is a solid block through which holes have been bored for the internal bore and the fastener receiving holes.

10. The hanger of claim 8 in which the hook comprises an inverted mount receiving slot, the inverted mount receiving slot being oriented 180 degrees to the first mount receiving slot.

11. The hanger of claim 8 in which the first mounting slot opens in a first direction, and the hook comprises a second mount receiving slot opening in the first direction.

12. A hanger, comprising:
a solid mounting block having a wall mounting face defining a mounting plane and an internal bore that is at least partially threaded, the internal bore extending parallel to the mounting plane;
a shaft threaded into the internal bore;
fastener receiving holes, each fastener receiving hole passing through the mounting block; and
a hook secured to the shaft, the hook having at least a first mount receiving slot.

13. The hanger of claim 12 in which the hook is secured to the shaft by threading.

14. The hanger of claim 13 in which the hook has internal threads for threading onto external threads of the shaft.

15. The hanger of claim 12 in which the hook comprises an inverted mount receiving slot, the inverted mount receiving slot being oriented 180 degrees to the first mount receiving slot.

16. The hanger of claim 12 in which the first mounting slot opens in a first direction, and the hook comprises a second mount receiving slot opening in the first direction.

17. The hanger of claim 12, further comprising:
a mounting bracket having a laterally extending edge;
the mounting block incorporating a lip extending perpendicular to the internal bore, the lip being configured to be supported by the laterally extending edge; and
the laterally extending edge being laterally wider than the lip of the mounting block.

18. A hanger, comprising:
a mounting block;
a shaft supported by the mounting block; and
a hook secured to the shaft, the hook having at least a first mount receiving slot and a second mount receiving slot oriented to open in the same direction as the first mount receiving slot.

19. The hanger of claim 18 further comprising an inverted mount receiving slot in the hook, the inverted mount receiving slot being oriented 180 degrees to the first mount receiving slot.
